(19) United States
(12) Patent Application Publication
(10) Pub. No.: US 2003/0029455 A1
(43) Pub. Date: Feb. 13, 2003

(54) Respiratory mask

(76) Inventors: Christopher G. Smith, Mosman (AU); Patrick J. McAuliffe, Carlingford (AU)

Correspondence Address: PILLSBURY WINTHROP, LLP, P.O. BOX 10500, MCLEAN, VA, 22102, US

(21) Appl. No.: 09/905,714

(22) Filed: Apr. 3, 2001

(51) Int. Cl. A62B 18/02

(52) U.S. Cl. 128/206.21; 128/207.13

(57) ABSTRACT

An apparatus and method, as embodied and broadly described herein, provide a respiratory mask for the application of positive pressure to the airways of a patient. The mask includes two chambers in which a first chamber is maintained with positive pressure with respect to the ambient pressure and contains a first opening which, when in use, is positioned against the patient's face. A second chamber, maintained at negative pressure with respect to the ambient pressure, contains a second opening which, when in use, is positioned against the patient's face, such that the face contacting area of the first opening is smaller than the face contacting area of the second opening.

### CROSS REFERENCE TO RELATED APPLICATION

This application is a conversion under 37 C.F.R. §1.53(c)(3) of U.S. Provisional Application No. 60/280,750, filed Apr. 3, 2001, the specification and drawings of which are incorporated herein by reference.

### BACKGROUND

1. Field of Invention

The invention relates to a respiratory mask for use in non-invasive positive pressure ventilation, such as, for example, in the treatment of Sleep Disordered Breathing (SDB). In particular, the invention relates to an apparatus and method for securing such a mask to a face through the use of pressure below the ambient pressure.

2. General Background and Related Art

Non-invasive positive pressure ventilation (NIPPV) techniques, such as, for example, the application of Continuous Positive Airway Pressure (CPAP), have been used for the treatment of SDB, such as Obstructive Sleep Apnea (OSA). Apparatuses for applying NIPPV typically comprise a blower, an air delivery conduit, and a patient interface. A number of different patient interfaces are known, such as nasal masks, nose and mouth masks, full-face masks, and nasal prongs and pillows. In all cases, some form of mask retaining feature, such as headgear, is required to position the mask on the face and to counterbalance the force which results from the application of pressurized air which seeks to push the mask of the face.

A nasal mask typically comprises a generally triangularly-shaped chamber constructed from a relatively rigid material, such as polycarbonate, with an open side which, when in use, is positioned against the face. The edge of the open side, e.g., face-contacting portion, helps form a seal on the patient's face. The face-contacting portion is typically soft to assist with patient comfort. It is important that there be a good seal with few leaks because leaks can cause air jetting and noise, which may be uncomfortable for the patient. Patient comfort is important since the patient must sleep while wearing the mask.

U.S. Pat. No. 4,770,169 (Schmoegner et al.), entitled “Anaesthetic Mask”, discloses “an improved anaesthetic scavenging face mask . . . having a scavenging channel formed along the perimeter of the respiratory chamber”. The scavenging channel is connected to a vacuum outlet. Schmoegner et al further discloses that the escape of anaesthetic gases (from an anaesthetic mask) into the operating room may have deleterious health effects on the staff in the operating room. For example, escaping gases may cause dentists or doctors to become anaesthetized.

As such, Schmoegner et al. provides a respiratory chamber having a perimeter, which effects a seal with the face of the patient. Schmoegner et al. characterizes a scavenging channel as a tubular enclosure proximate the peripheral edge of the chamber, being formed entirely within the seal. The mask has a plurality of vacuum holes along the perimeter of the mask to scavenge leaking gases. FIG. 1 of Schmoegner et al. is reproduced as FIG. 2 (Prior Art) of this application. FIG. 2 illustrates that the vacuum holes of Schmoegner et al. are relatively small.

U.S. Pat. No. 5,803,076 (Myers), entitled “Vacuum Adherent Face Mask”, discloses a face mask including a bladder attached to the periphery of the mask body, with a plurality of perforations and vacuum means for producing sub-atmospheric pressure in the bladder when the mask is engaged with a human face. Much like Schmoegner et al., the perforations of the Myers face mask are relatively small.

In most mask systems, there exists the potential for leak flow. For example, if the mask is not correctly positioned on the face, or unsuitable for a particular face, there may be leak around the periphery of the face-contacting portion of the mask. In some NIPPV applications, it is important to measure accurately the leak from the system, for example in a spontaneously breathing patient, to assist in correctly synchronizing the blower flow with patient respiratory effort.

### SUMMARY

Apparatuses and methods consistent with the principles of the present invention provide a novel respiratory mask capable of being secured to a face through the use of pressure below the ambient pressure.

Accordingly, an apparatus and method, as embodied and broadly described herein, provide a respiratory mask for the application of positive pressure to the airways of a patient. The mask includes two chambers, in which a first chamber is maintained with positive pressure with respect to the ambient pressure and contains a first opening which, when in use, is positioned against the patient's face. A second chamber, maintained at negative pressure with respect to the ambient pressure, contains a second opening which, when in use, is positioned against the patient's face, such that the face contacting area of the first opening is smaller than the face contacting area of the second opening.

Also among the inventions disclosed herein is a method of continuously measuring the leak flow from the first chamber. This method includes continuously measuring the flow of air from the second chamber. The disclosed method is useful with a respiratory mask having a first chamber at positive pressure with respect to ambient pressure in fluid communication with a patient's airways, a second chamber at negative pressure with respect to ambient pressure, and a conduit in fluid communication with the second chamber.

### BRIEF DESCRIPTION OF THE DRAWINGS

The present invention may be understood and appreciated from the following detailed description, taken in conjunction with the drawing in which:

FIG. 1 depicts a prior art full-face mask and headgear;

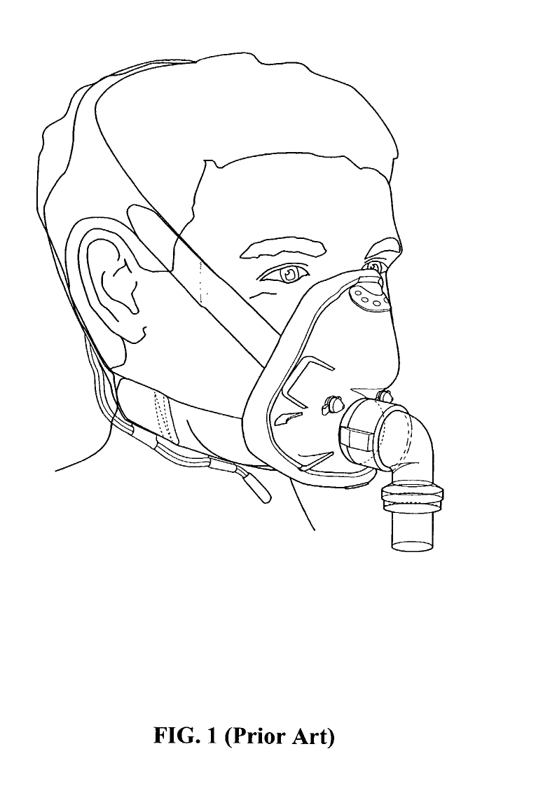

FIG. 2 depicts a prior art anaesthetic mask;

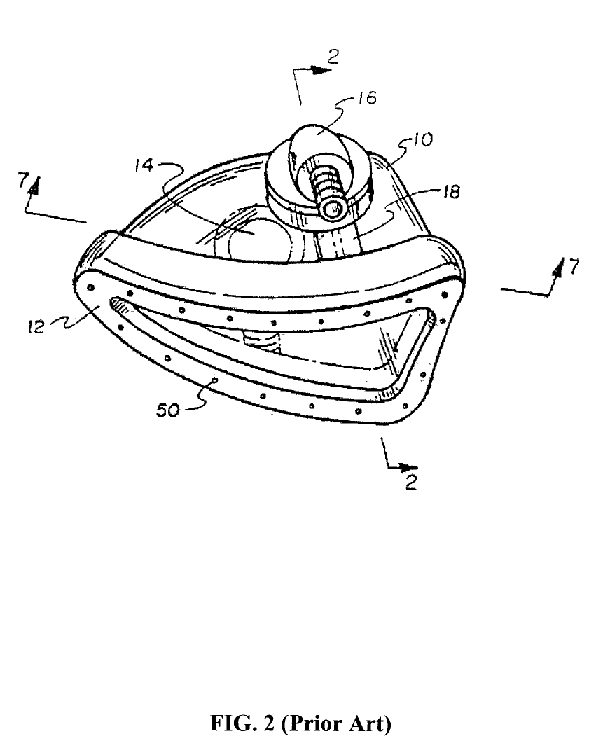

FIG. 3 illustrates a top cross-sectional view of a mask, constructed and operative in accordance with an embodiment of the invention;

FIG. 4 illustrates a mask and flow generator, constructed and operative in accordance with an embodiment of the invention;

FIG. 5 illustrates a profile view of a face with a mask constructed and operative in accordance with an embodiment of the invention.

### DETAILED DESCRIPTION

The following detailed description of the present invention refers to the accompanying drawings that illustrate embodiments consistent with this invention. Other embodiments are possible and modifications may be made to the embodiments without departing from the spirit and scope of the invention. Therefore, the following detailed description is not meant to limit the invention.

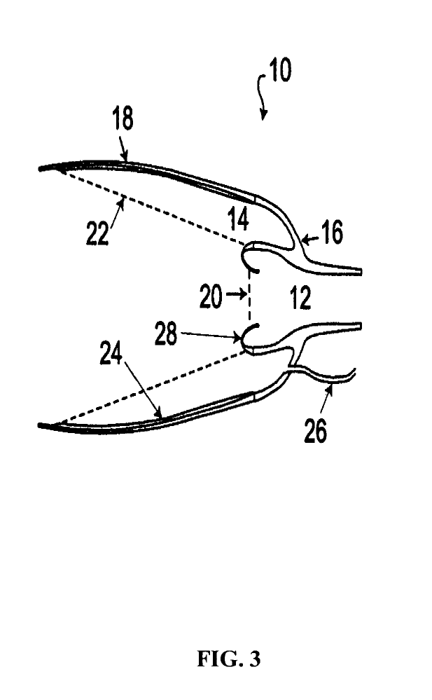

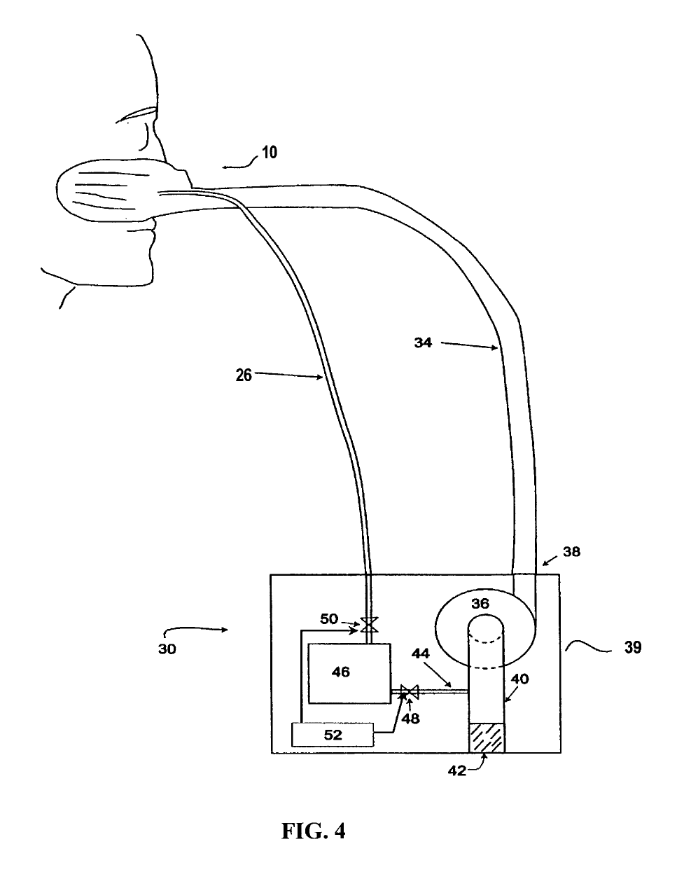

FIG. 3 illustrates a top cross-sectional view of a mask 10 according to an embodiment of the invention. FIG. 4 illustrates an embodiment of the invention including mask 10 and flow generator 30.

As indicated in FIG. 3, mask 10 comprises at least two chambers, a first chamber 12, at positive pressure with respect to the ambient pressure, and a second chamber 14, at negative pressure with respect to the ambient pressure. First chamber 12 is in fluid communication with the patient's airways.

As shown in FIG. 4, air, at positive pressure with respect to ambient pressure, passes from a blower outlet 38, located in a main housing 39 of flow generator 30, through an air delivery conduit 34 to the first chamber 12. The positive pressure relative to ambient pressure in first chamber 12, denoted P₁, is maintained according to a treatment regime. The first chamber 12 has an open side 20 which, when in use, is positioned against the patient's face. The first chamber open side 20 has a cross-sectional area, denoted A₁.

Second chamber 14 is in fluid communication via a small diameter tube 26 with a reservoir of air at a negative pressure with respect to ambient pressure. In one embodiment, the reservoir is located within the main housing 39 of flow generator 30. Second chamber 14 has an open side 22 with a cross-section area, denoted A₂, which is larger than A₁. The pressure in second chamber 14 is denoted P₂. The relative positive pressure P₁ in first chamber 12 causes a force, denoted F₁, which pushes mask 10 off the face and the relative negative pressure in second chamber 14 holds mask 10 on to the face with a force denoted F₂.

In one embodiment, pressure P₂ in second chamber 14 is controlled according to the following equation:

$${P}_{2} = {P}_{a t m} - \frac{{A}_{1}}{{A}_{2}} {P}_{1} + K \qquad ( 1 )$$

where Pₐₜₘ is atmospheric pressure (with units of, for example, kPa).

In one implementation, the constant K in equation (1) is configured to be zero. In such a case, the two forces F₁, F₂ are configured to exactly counterbalance each other. In another implementation, constant K is configured to be a positive number, in which holding force F₂ of second chamber 14 does not completely counterbalance the first chamber 12 pushing force F₁. As such, headgear or other retaining features are required to assist holding mask 10 in place.

In yet another embodiment, K is configured to be a negative number, which provides for a “safety margin”. In such a case, the second chamber 14 holding force F₂ exceeds the first chamber 12 pushing force F₁.

Mask 10 includes a rigid piece 16, which forms the non-face contacting portions of both chambers 12, 14 and two flexible pieces 18 and 28, which form the face contacting portions of the second 14 and first 12 chambers, respectively. Flexible piece 28, which forms the face contacting portion of first chamber 12 is constructed from a material such as silicone, in a similar manner to known nasal masks such as the MIRAGE™ mask (ResMed, Ltd). Flexible piece 18, which forms the face contacting portion of second chamber 14 includes, in one embodiment, ribs 24 which help support the structure of second chamber 14, so as to increase the face contacting area 22 of the second chamber.

As shown in FIG. 4, the mask 10 is connected to a flow generator 30 via two conduits 34 and 26 from the first and second chambers 12, 14, respectively. In one implementation, the two conduits 26, 34 are molded integrally in a single tube. Conduit 26, is at negative pressure with respect to the ambient pressure and must be sufficiently rigid to withstand the compressing force. Conduit 34 is at positive pressure with respect to ambient pressure and must be able to withstand the resulting expansion forces.

Conduit 34 is connected to blower outlet 38 of flow generator 30, in a similar manner to conventional CPAP devices. Blower 36 has an air inlet tube 40, which draws in air at ambient pressure via an air filter 42.

The flow of air from the air inlet tube 40 to a negative pressure reservoir 46 via a conduit 44 is controlled by a valve 48 which is, in turn, under the control of a controller 52. The flow of air from negative pressure reservoir 46 to second chamber 14 via conduit 26 controlled by valve 50 which is, in turn, under the control of controller 52. When blower 36 draws in air from the exterior of the flow generator 30, a negative pressure is created in air inlet tube 40. When the pressure in air inlet tube 40 is below that of negative pressure reservoir 46, valve 48 opens allowing the pressure to equalize.

When a seal with the face is maintained by the second chamber 14, the only source of air travelling from mask 10 to the patient via conduit 26 is from first chamber 12. In one implementation, a flow meter, such as a differential pressure transducer, may be included to measure the flow rate of air along conduit 26 and hence measure the leak flow from first chamber 12.

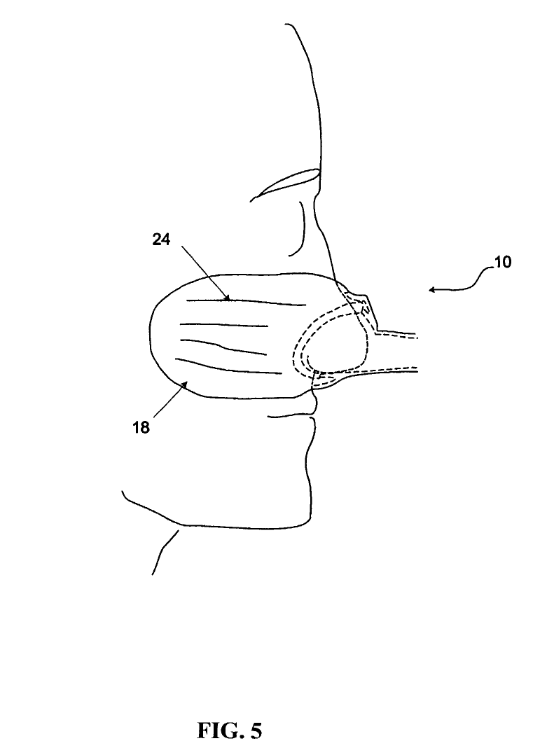

FIG. 5 shows a profile view of a face with mask 10 according to an embodiment of the invention. In this figure, mask 10 is worn by the patient without any headgear. Flexible pieces 18 form the face contacting portions of second chamber 14. Flexible piece 18 which forms the face contacting portion of second chamber 14 includes ribs 24 to assist supporting the structure of second chamber 14, so as to increase the face contacting area of second chamber 14.

In one implementation, a separate blower may be included to create the appropriate relative negative pressure in second chamber 14 when necessary. In yet another implementation, headgear may be included to assist in holding mask 10 on the face. However, since mask 10 has an intrinsic holding force, via second chamber 14, the headgear need not be tightened as much as conventional apparatuses with no intrinsic holding force.

In a further implementation, second chamber 14 may be subdivided into a plurality of independent negative pressure chambers, each with a one way valve connected to the source of negative pressure. In this manner, if the integrity of one negative pressure chamber is compromised causing a “loss” of negative pressure, the integrity of the other chambers will not necessarily be affected and mask 10 will still hold to the face.

The foregoing description of preferred embodiments of the present invention provides illustration and description, but is not intended to be exhaustive or to limit the invention to the precise form disclosed. Modifications and variations are possible consistent with the above teachings or may be acquired from practice of the invention. Accordingly, it will be appreciated by persons skilled in the art that the present invention is not limited to what has been particularly shown and described hereinabove.

What is claimed is:

1. A respiratory mask for application of positive pressure to airways of a patient, comprising:
a first chamber maintained with positive pressure with respect to ambient pressure and containing a first opening that, when in use, is positioned against a patient's face, and
a second chamber, maintained at negative pressure with respect to the ambient pressure, and containing a second opening that, when in use, is positioned against the patient's face, such that a face contacting area of the first opening is smaller than a face contacting area of the second opening.
